(19) United States
(12) Patent Application Publication
(10) Pub. No.: US 2021/0176976 A1
(43) Pub. Date: Jun. 17, 2021

(54) METHOD FOR MONITORING AND/OR CONTROLLING A DEPLOYMENT PROCESS OF A SPRAY LIQUID AT A SPRAY NOZZLE UNIT

(71) Applicant: Robert Bosch GmbH, Stuttgart (DE)

(72) Inventors: Jochen Glasbrenner, Stuttgart (DE); Olaf Ohlhafer, Erligheim (DE); Hans-Arndt Freudigmann, Tuebingen (DE)

(21) Appl. No.: 16/760,809

(22) PCT Filed: Oct. 26, 2018
(86) PCT No.: PCT/EP2018/079368

§ 371 Date: Apr. 30, 2020

(30) Foreign Application Priority Data
Nov. 10, 2017 (DE) 10 2017 220 024.3

(51) Int. Cl. A01M 7/00; A01C 23/00; B05B 12/00; B05B 13/00; B05B 12/08

(52) U.S. Cl. CPC A01M 7/0089; A01C 23/007; B05B 12/08; B05B 13/005; B05B 12/004

(57) ABSTRACT

A method is provided for monitoring and/or controlling a deployment process of a spray liquid having a defined active agent concentration at at least one spray nozzle unit of a spray device for deploying the spray liquid for agricultural purposes. The method includes: receiving at least one property signal including a piece of property information of the spray liquid detected with the aid of a sensor unit of the spray device in a through-flow area of the spray nozzle unit, an active agent concentration in the spray liquid being ascertainable using the property information; and outputting an information signal to a display unit and/or a control signal to the spray nozzle unit as a function of the received property information of the spray liquid and/or of an active agent concentration in the spray liquid ascertained using the property information, in order to monitor and/or to control the deployment process.

### FIELD

The present invention relates to a method for monitoring and/or controlling a deployment process of a spray liquid having a defined active agent concentration at at least one spray nozzle unit of a spray device for deploying the spray liquid, in particular, for agricultural purposes. The resent invention also relates to a control unit and a computer program.

### BACKGROUND INFORMATION

In conventional systems today for the direct feed of plant protection agents to a field sprayer, the line lengths provided through the central feed point of the plant protection agents into the carrier stream cause significant delay times until the plant protection agent is present at the nozzle. Thus, delay times of over 20 seconds may occur between the central metering and the deployment of the spray liquid at the nozzle. However, field sprayers without direct feed also experience delay times at the start of the application if the field sprayer has been flushed beforehand with water. This water must first be removed from the system or be pumped to the spray liquid tank.

Long delay times result if the point at which the plant protection agent is fed into the carrier stream (water stream) in direct-feeding systems is far removed from the nozzles on a field sprayer. Different line lengths result in shorter delay times in the middle of the spray bar and longer delay times at the outer segments, so that in the case of a planar application, the plant protection agent is more likely discharged inwardly than outwardly. Commencing the application during the travel on the field results in the so-called butterfly effect. This butterfly effect also occurs at the start of an application in conventional premix systems, in which the spray liquid is metered manually by the operator and is mixed in a central spray liquid tank.

To avoid the butterfly effect, it is possible to pump the spray liquid in circles with the aid of ring lines. This “preloading” at the nozzles minimizes the delay times. However, the volume pumped during the preloading must either be returned to a spray liquid tank, if present, or be stored in a collection tank. If the spray liquid is returned to a spray liquid tank, then it must be ensured that the concentration of the plant protection agent in the spray liquid tank is not altered by the additional quantity of water in the tank. Thus, this system is not immediately suitable for a direct feed system that includes a small mixing tank or that includes no mixing tank at all. Additional return lines are required for the ring line in any case.

German Patent Application No. DE 10 2004 030 240 A1 describes a device for distributing spreading material, the metering unit for the spreader lines for the partial widths being connected from the outside to the inside at the start of the operation so that at the head of the field the distribution process starts uniformly over the entire operating width.

German Patent Application No. DE 10 2009 026 234 A1 describes a field sprayer including sensors for ascertaining and setting an active agent concentration in a spray liquid.

### SUMMARY

The present invention provides a method for monitoring and/or controlling a deployment process of a spray liquid having a defined active agent concentration at at least one spray nozzle unit of a spray device for deploying the spray liquid, in particular, for agricultural purposes. In an example embodiment of the present invention, the method including the steps:
receiving at least one property signal including a piece of property information detected—during the deployment process—with the aid of a sensor unit of the spray device in a through-flow area of the spray nozzle unit, an active agent concentration being ascertainable in the spray liquid using the property information; and
outputting an information signal to a display unit and/or a control signal to the spray nozzle unit as a function of the received property information of the spray liquid and/or of an active agent concentration in the spray liquid ascertained using the property information, in order to monitor and/or to control the deployment process.

The present invention also provides a control unit, which, in one example embodiment, is configured to carry out all steps of a previously described method.

The present invention also provides a spray device including at least one spray nozzle unit for deploying a spray liquid, in particular, for agricultural purposes. In accordance with an example embodiment of the present invention, the spray device includes:
a sensor unit for detecting—during the deployment process—a piece of property information of the spray liquid in a through-flow area of the spray nozzle unit, an active agent concentration in the spray liquid being ascertainable using the property information; and
a previously described control unit, in order to monitor and/or to control a deployment process of a spray liquid having a defined active agent concentration at the spray nozzle unit.

Finally, the present invention provides a computer program, which, in one example embodiment, is configured to carry out all steps of a previously described method, as well as a machine-readable memory medium on which the computer program is stored.

A deployment process may be understood within the scope of the present invention to mean a deployment of a spray liquid having a defined active agent concentration at at least one, in particular, at each spray nozzle unit of the spray device, in order to “preload” the spray device. The deployment in this case takes place in such a way that—prior to the actual treatment of the agricultural area—a portion of the spray liquid having a less than desired active agent concentration is deployed (for example, water with no active agent or having a minimal active agent concentration), so that the spray liquid having the desired active agent concentration is present at the spray nozzle units at the start of the treatment. The deployment process may be implementable for a defined or predefined duration, i.e., may stop automatically after a defined or predefined duration. The deployment process may be stopped or terminated with the aid of the control signal. The deployment process is carried out with the aid of the spray nozzle unit or spray nozzle units. The deployment process at a spray nozzle unit is terminated when the spray nozzle units are deactivated or closed. The entire deployment process is terminated when each of the spray nozzle units is deactivated or closed.

An agricultural purpose is understood within the scope of the present invention to mean a purpose, which is directed to an economic cultivation of crop plants.

The example spray device may, in particular, be part of an agricultural field sprayer or a plant protection device, or may be designed as an agricultural field sprayer or a plant protection device. The spray device may be attachable and/or attached on or at a mobile unit. The mobile unit may be designed as a farm vehicle and/or as an aircraft and/or as a trailer. The mobile unit may, in particular, be an agricultural machine, for example, a truck, a tractor or a (self-propelled or autonomous) field sprayer. The spray device may also be attached to a hydraulic device of the agricultural machine. It is also possible that the spray device is built on a loading platform of the agricultural machine. Alternatively, the spray device may be coupled to the agricultural machine.

The spray liquid in this case is preferably deployed on a field. A field in the present case may be understood to mean an agricultural area or an area utilized for agriculture, a cultivation acreage for plants or also a parcel of such an area or crop area. The field may thus be arable land, grassland or pasture land. The plants may include crop plants, for example, whose yield is utilized agriculturally (for example, as foodstuff, animal feed or as energy crop), as well as waste plants, weeds and grass weeds. The plants may be part of the agricultural land.

In addition to the liquid to be deployed for the agricultural treatment and including the desired active agent concentration, the term “spray liquid” within the scope of the present invention also includes the liquid which is deployed in connection with the deployment process, in order to provide the spray liquid having the desired active agent concentration at the spray nozzle unit (for example, water with no active agent or having a minimal active agent concentration). The term “spray liquid” within the scope of the present invention further includes both the entire spray liquid as well as only a portion or fraction, in particular, a spatially limited portion or fraction of the spray liquid in the spray device. The spatially limited portion or fraction of the spray liquid may, for example, be the portion of spray liquid situated in a spray nozzle unit.

The spray liquid to be deployed includes at least one active agent. The active agent may include a “spray,” i.e., a preparation or plant protection agent, in particular, a plant protection agent concentrate. Accordingly, the active agent may, for example, include an herbicide, fungicide or an insecticide (pesticide). The spray liquid may be a spray mixture. However, the active agent may also be a fertilizer, in particular, a fertilizer concentrate. Accordingly, the active agent may include a liquid fertilizer and/or a growth regulator. The active agent may be formed as a liquid or as a solid, for example, in the form of granulates or as a pre-dissolved solid, for example, in the form of pre-dissolved granulates.

The spray liquid to be deployed preferably further includes a liquid, in particular, a carrier liquid for diluting the active agent. A carrier liquid may be understood within the scope of the present invention to mean a liquid, which is designed to be intermixed with the active agent in order to enable or improve a deployment or delivery of the active agent, for example, of the plant protection agent or of the fertilizer. It is also possible that an active agent present as a solid or a granulate is suspended in the carrier liquid. It is further possible that a non-soluble active agent in the carrier liquid is emulsified in the carrier liquid. The carrier liquid is preferably water.

Accordingly, the spray liquid may be formed as: a liquid, a suspension, an emulsion, a solution or a combination thereof. The spray liquid is designed preferably as a plant protection agent diluted with water or a fertilizer diluted with water.

The example spray device preferably includes a spray liquid tank for accommodating the spray liquid and at least one spray nozzle unit for deploying the spray liquid. The spray liquid may be fed or conducted from the spray liquid tank to the spray nozzle unit with the aid of a spray liquid line or multiple spray liquid lines. A line or spray liquid line may be understood within the scope of the present invention to also mean a section of the corresponding line or of the spray liquid line. The line may be designed as fluidic connection line, for example, in the form of a pipe, a hose, a duct or a tube.

The spray liquid may be filled ready-mixed into the spray liquid tank of the spray device. The spray liquid may, however, also first be mixed in the spray device. To mix the spray liquid, the spray device may include (in the flow direction of the spray liquid) a mixing unit upstream from the spray liquid tank, into which the liquid is fed or conducted from a liquid tank of the spray device, and the active agent from an active agent tank of the spray device. In this case a liquid delivery unit may be provided, which is designed to conduct or deliver the liquid from the liquid tank via a liquid line to the mixing unit in a targeted or defined manner. An active agent delivery unit may also be provided, which is designed to conduct or deliver the active agent from the active agent tank via an active agent line to the mixing unit in a targeted or defined or metered manner. The delivery units may include one or multiple metering units or metering components. The metering units or metering components may include one or multiple pumps or metering pumps and valves. At least one of the delivery units may be designed to generate the spray pressure at the spray nozzle unit, i.e., the pressure with which the spray liquid is deployed.

A mixing unit may be understood within the scope of the present invention to mean a unit, which is designed to intermix or blend, preferably as homogenously as possible, at least the liquid and the active agent with one another to form the spray liquid. The mixing unit may include a mixing element or agitator element, in order to actively intermix the liquid and the active agent with one another. The agitator element may be designed as an agitator blade or a propeller. The mixing unit may include a mixing tank including at least one inlet each for the liquid and for the active agent. This means in other words that the liquid and the active agent may be fed separately, i.e., with the aid of separate lines, directly into the mixing unit or the mixing tank. Alternatively, a shared inlet may be provided at the mixing unit in the form of a T-piece, the active agent being initially fed to the liquid or introduced into the liquid and subsequently fed together with the liquid into the mixing unit. The mixing unit or the mixing tank may include at least one outlet for the intermixed or blended spray liquid, for example, in a lower area. It is also possible that the mixing unit is designed as a static mixing unit or a static mixer. The mixing unit may, however, also be designed only as a T-piece, so that a passive intermixing takes place in the mixing unit.

The mixing unit may also be integrated into the spray liquid tank. Accordingly, the spray liquid tank may be designed as a mixing tank of the mixing unit. The mixing element and/or agitator element in this case may be situated at or in the spray liquid tank, in order to intermix or blend the spray liquid.

The spray liquid tank may, however, also be situated in the spray liquid line downstream from the mixing unit. This means in other words that the spray liquid tank is situated in the flow direction of the spray liquid from the mixing unit to the spray nozzle unit behind or after the mixing unit. The spray liquid tank may thus be spatially situated in the spray liquid line between the mixing unit and the spray nozzle unit. The spray liquid tank may be designed as a buffer tank, so that the spray liquid is feedable or fillable from the mixing unit initially into the buffer tank and feedable or deliverable or conductable from the buffer tank to the spray nozzle unit as needed.

The example spray device may also include a spray liquid delivery unit, which is situated in, and/or is integrated into, the spray liquid line downstream from the spray liquid tank or buffer tank. The spray liquid delivery unit may then be designed to conduct the spray liquid from the spray liquid tank or buffer tank under pressure or under a defined pressure to the spray nozzles or spray nozzle units. The spray liquid delivery unit may be designed, in particular, to generate a constant pressure, i.e., may be designed as a constant pressure system, in order to generate a constant or uniform spray pressure at the spray nozzles or spray nozzle units. Since the defined spray pressure is generated by the spray liquid delivery unit, the delivery units upstream from the buffer tank, i.e., the liquid delivery unit and the active agent delivery unit, may be very simply designed, since they need only assume the task of feeding the liquid or the active agent into the buffer tank.

If the spray liquid delivery unit is integrated into the buffer tank, the buffer tank may be designed as a pressure accumulator, for example, including media separation (spray liquid—air). The pressure regulation in the buffer tank may then take place via a pneumatic pressure regulating valve, so that potential pressure fluctuations in the system may be reduced. The spray liquid delivery unit is preferably, however, situated downstream from the spray liquid tank, as a result of which the buffer tank may be designed to be pressureless. In this case, the buffer tank may be designed to be pressureless, for example, with the aid of a ventilation hole. The ventilation hole may include a ventilation valve. This means in other words that the buffer tank is fluidically connected to the surroundings, or is connectable at a defined internal pressure, so that it is designed to be pressureless. With this measure, the liquid delivery unit and the active agent delivery unit need preferably no longer operate against the high system pressure but merely against the ambient pressure (and the counter pressure occurring due to losses of flow), so that the pressure requirements of the corresponding pumps or metering pumps are further reduced. The liquid delivery unit may, for example, include a simple flow pump or delivery pump, which has a mere ON/OFF functionality. The required metered volume flow of the active agent may then be ascertained and the active agent metering pump may be activated via the volume flow signal and the previously adjusted mixing ratio in connection with a volumetric flow meter. Alternatively, the liquid delivery unit may include a metering pump having a fixed delivery ratio (without measurement of the delivery volume). It is also possible that the liquid delivery unit includes a simple valve or a proportional valve in connection with a volumetric flow meter and a constant pressure source in the liquid line. It is also possible that the liquid delivery unit includes a constant pressure source and a metering orifice. As an alternative to the metering pump, the active agent delivery unit may include a simple delivery pump in connection with a volumetric flow meter (regulation). The active agent delivery unit in this case may additionally include at least one metering orifice. The buffer tank may also be designed very simply and essentially with no static requirements, as a result of which the overall costs may be further reduced.

The spray nozzle unit includes in each case at least one spray nozzle for deploying the spray liquid and at least one valve for controlling or regulating the deployed quantity of spray liquid. Accordingly, the spray nozzle unit is controllable or actuatable, i.e., designed to be openable and closable. Each of the spray nozzle units is preferably separately activatable, in particular, as a function of the property information in the associated through-flow area. The valve may be situated in or integrated into the spray nozzle. The valve may, however, also be situated in front of the spray nozzle, i.e., (in the flow direction of the spray liquid) upstream from the spray nozzle. The spray nozzle unit may, however, also include multiple spray nozzles, each including an upstream valve. The spray nozzle unit may further also include multiple spray nozzles including only one valve upstream from the spray nozzles, so that when actuating the valve, the spray liquid is deployed with the aid of all spray nozzles of the spray nozzle unit. Accordingly, the spray nozzle unit may be designed as a part-width section of a nozzle system. The spray nozzle unit may also include a final mixing unit, which is designed to intermix the spray liquid with the liquid and or with the active agent and/or with an additional active agent—which are conductable or feedable with the aid of corresponding lines to the final mixing unit. In this case, it is advantageous to provide a combination of the final mixing unit and the previously described mixing unit, which in this case would be designed as a pre-mixing unit, in order to obtain a two-stage mixing system.

The through-flow area of the spray nozzle unit, in which the property information of the spray liquid is detected, is an area through which spray liquid is flowable. Accordingly, this is an area, which comes into contact with the spray liquid, in particular, during the deployment process of the spray liquid. The through-flow area is preferably situated in at least one component, which is selected from the group made up of: spray nozzle, valve, spray liquid line of the spray liquid unit. The through-flow area may include a section of an interior space or the interior space as a whole of the corresponding component. The through-flow area is preferably situated in or directly in front of the spray nozzle or spray nozzles.

The sensor unit may include a sensor element or a sensor or also multiple sensor elements or sensors. The sensor unit may be situated in the through-flow area. The sensor unit in this case may be in direct contact with the spray liquid in order to detect the property information of the spray liquid. The sensor unit may, however, also be situated outside the through-flow area. The sensor unit in this case may be designed to detect the property information of the spray liquid in a contactless manner. In addition to the property information, the sensor unit may be designed to detect a temperature of the spray liquid in the through-flow area. The sensor unit may include a transmission unit. The transmission unit may be designed to transmit or to send the property signal including the detected values or measured values of the property information wirelessly, for example, via radio, WLAN, Bluetooth, etc., and/or in a hardwired manner.

The property signal includes a detected piece of property information and a detected value/measured value of the property information. The property information is detected during the deployment process. An active agent concentration in the spray liquid is ascertainable using the detected property information or the detected value of the property information. This means in other words that an active agent concentration in the spray liquid is (directly or indirectly) derivable from the property information. In particular, the property information of the spray liquid and the active agent concentration in the spray liquid are essentially uniquely a function of one another. The property information of the spray liquid and the active agent concentration in the spray liquid in this case may be a linear function of one another. Accordingly, it is possible to deduce the active agent concentration in the spray liquid with the aid of the detected property information or the detected value of the property information. The property information may include a physical and/or chemical and/or bodily and/or material property of the spray liquid. The detected property information is preferably selected from the group made up of: electrical property, in particular, electrical conductivity or permittivity, visual property, in particular, absorption property, emission property, fluorescence, sound velocity, or a combination thereof. In this way, it is possible with the aid of conventional computing methods to very easily ascertain an active agent concentration in the spray liquid. The detected property information is preferably an electrical conductivity.

Thus, for example, the electrical conductivity of a solution is a universal physical variable and indicates the ability of a material to conduct an electrical current. This conductivity is highly a function of the quantity of dissolved salts, which are to be found either already in the active agents or the sprays, or which could also be added to the active agent by the manufacturers or the farmers. Other physically measurable material variables, in addition to conductivity, may also be utilized for determining the concentration of the active agent. Thus, the clouding of the solution (and thus the absorption coefficient for light) also changes with the concentration of the active agent in water due to the proportion of undissolved particles in the solution, or also the sound velocity (in particular, as a function of the density and compressibility of the medium). There is also the possibility of deducing the concentration of the active agent, for example, via fluorescence measurements. Here, a type of tracer (for example, a dye) could also be added to the active agents.

The steps of receiving the property signal and of outputting the information signal and/or the control signal may be carried out with the aid of a control unit. The ascertainment or calculation of the active agent concentration in the spray liquid may also be carried out with the aid of the control unit and of conventional computing methods. A control unit in the present case may be understood to mean an electrical device, which processes sensor signals and outputs control signals and/or information signals/data signals as a function thereof. For this purpose, the control unit may include at least one processing unit for processing the property signals or pieces of property information. The processing unit may, for example, be a signal processor, a microcontroller or the like. The control unit may further include at least one memory unit for storing the property signals or pieces of property information or may be connected for this purpose to a memory unit. The memory unit may include a cloud server, a flash memory, an EPROM or a magnetic memory unit. The control unit may also include at least one communication interface for reading in the property signals and for outputting the information signals and/or the control signals. The communication interface may be designed to read in or output the signals wirelessly, for example, via radio, WLAN, Bluetooth, etc., and/or in a hardwired manner. The communication interface may be designed in hardware and/or in software. In a hardware design, the interface may, for example, be part of a so-called system ASIC, which contains a wide variety of functions of the control unit. It is also possible, however, for the interface to include dedicated integrated circuits or to be made at least partly of discrete components. In a software design, the interface may be a software module, which is present, for example, on a microcontroller alongside other software modules.

The step of outputting takes place as a function of the property signal or of the received property information of the spray liquid and/or of an active agent concentration in the spray liquid ascertained using the property information. This means in other words that it is decided as a function of the property information or of the detected value of the property information and/or of the active agent concentration or of the ascertained value of the active agent concentration whether a signal and/or what type of signal, if necessary, also including which content, is output.

In this case, in a step of comparing at least a value of the property information and/or the active agent concentrations in the spray liquid with a predefinable reference value and/or a predefinable reference value range of the property information and/or of the active agent concentration is carried out, in order as a function thereof, to output the information signal and/or the control signal. The term “predefinable” within the scope of this present invention also encompasses the term “predefined.” The step of comparing values within the scope of this present invention further encompasses a comparison of a curve of values. It may in turn then be decided as a function of the comparison whether a signal is output and, if necessary, which type of signal, i.e., including which content. The information signal is output preferably to the display unit and/or the control signal when the value of a piece of property information and/or of an active agent concentration in the spray liquid has reached the reference value and/or the reference value range and/or with a defined deviation thereof. The reference value or the reference values may, in particular, be input manually, calculated and/or read out from a table. The reference value and/or the reference value range and/or the reference gradient value is/are a function, in particular, of the active agent. For example, the information signal and/or the control signal could be output with a deviation of 1% of the average value of the values of the property information. The step of comparing may be carried out with the aid of the processing unit of the control unit.

The control signal may be designed to deactivate or to close the spray nozzle unit, in order to terminate the deployment process. In this case, the reference value may be an upper limiting value or the reference value range may be an upper limiting value range, the deployment process being terminated when the value has reached the upper limiting value or limiting value range. The control signal may, however, also be designed to activate the spray nozzle unit in order to restart the deployment process. In this case, the reference value may be a lower limiting value or the reference value range may be a lower limiting value range, the spray process being restarted when the value deviates from the lower limiting value or limiting value range.

The information signal may be designed, to activate the display unit in such a way that a “simple” alarm signal, for example, in the form of a visual and/or acoustic and or haptic signal is output by the display unit. In this case, a corresponding color signal, for example, may be output as a function of the comparison. The information signal may, however, also include the value of the property information and/or of the active agent concentration of the spray liquid, and may be designed to be displayed on the display unit. The information signal may further include a value of the required duration of the deployment process. The display unit in this case may be a display, a smartphone or an arbitrary other terminal such as, for example, a tablet or a PC. The information signal may, for example, be selected from the list made up of: SMS, email, push-notification, telephone call.

Alternatively or in addition, it is possible that the information signal including the value of the property information and/or the active agent concentration of the spray liquid is output to the display unit “generally” at and/or after termination of the deployment process, in particular, initially or only or exclusively at and/or after termination of the deployment process, in particular, during the entire duration of the deployment process. The deployment process in this case may be terminated in a targeted and/or automatic and/or premature manner.

The example method for monitoring and/or controlling may be started automatically or manually. The method may be started as a function of the deployment process. In this case, the deployment process may have also been started automatically or manually. The method may be started at the beginning or after a defined duration after the beginning of the deployment process. The method may be carried out during the entire duration of the deployment process or at defined points in time after the beginning of the deployment process. The method may also be carried out at and/or after the termination of the deployment process, in particular, not until or only or solely at and/or after the termination of the deployment process.

The example method for monitoring and/or controlling a deployment process of a spray liquid having a defined active agent concentration at at least one spray nozzle unit of a spray device for deploying the spray liquid, in particular, for agricultural purposes, may accordingly include the following steps:
activating at least one spray nozzle unit of the spray device in order to start the deployment process;
detecting a piece of property information of the spray liquid in a through-flow area of the spray nozzle unit with the aid of a sensor unit of the spray device, an active agent concentration in the spray liquid being ascertainable using the property information; and
outputting an information signal to a display unit and/or a control signal to the spray nozzle unit as a function of the received property information of the spray liquid and/or of an active agent concentration in the spray liquid ascertained using the property information, in order to monitor and/or control the deployment process.

With the example method according to the present invention and the example spray device according to the present invention, it is now possible to monitor and to optimize the deployment process at the spray nozzle units in a simple and cost-efficient manner. By detecting the property information of the spray liquid in a through-flow area of the spray nozzle unit, it is possible to then stop or terminate the monitored deployment process in a targeted manner when the desired defined active agent concentration is present at the corresponding spray nozzle unit, or the active agent concentration has reached a reference value. As a result only as much spray liquid as necessary is deployed during the deployment process on the one hand, and it is ensured, on the other hand, that the desired active agent concentration is present at each of the spray nozzle units, so that the introductorily explained butterfly effect may be prevented. If at the beginning of the deployment or application, the spray device is still filled with clean water from the last spraying process, this clean water may be safely deployed on the field by deployment from the spray nozzle units. This deployment process is stopped for each spray nozzle unit exactly when a defined active agent concentration is present at or in the spray nozzle unit. The spray device is thereby preloaded. On the one hand, the deployment of the water on the field has the advantage that the water still present in the spray device need no longer be pumped back into a spray liquid tank, where it potentially reduces the concentration of the active agent in the spray liquid tank, or where a collection tank is required. On the other hand, the entire line system for the return flow is omitted. On the other hand, the farmer may be informed via a display unit that the deployment process was not sufficient or not successful if an excessively low active agent concentration is measured in at least one of the spray nozzle units after the termination of the deployment process. As a result, he/she may initiate appropriate measures such as, for example, starting an additional deployment process.

It is also advantageous if an additional step of receiving at least one additional property signal is provided, including a piece of property information of the spray liquid ascertained with the aid of an additional sensor unit of the spray device in a through-flow area of an additional spray nozzle unit, in order as a function thereof to output pieces of property information in an information signal to the display unit and/or the control signal to the additional spray nozzle unit. It is advantageous, in particular, if the property information of the spray liquid is detected and a corresponding property signal is received in each case in a through-flow area of each of the spray nozzle units, in order as a function thereof to output pieces of property information in the information signal to the display unit and/or a corresponding control signal to the respective spray nozzle unit. For example, one control signal each may be output to the respective spray nozzle units and the deployment process may thus be terminated if the defined active agent concentration is detected or the active agent concentration has reached a reference value in all spray nozzle units in which the property information is detected. With this measure, it is possible to achieve an optimal and complete “preloading” of the spray device.

It is also advantageous if the value and/or the reference value and/or the reference value range of the property information and/or of the active agent concentration is/are ascertained using the property information of a carrier liquid of the spray liquid detected with the aid of an additional sensor unit. With this measure, it is possible to carry out the method even more precisely, since the actual property information of the carrier liquid is detected without an active agent as a “base value” and is taken into consideration or is factored out in the ascertainment of the aforementioned values.

It is also advantageous if the value and/or the reference value and/or the reference value range of the property information and/or of the active agent concentration is/are ascertained using a temperature of the spray liquid and/or of the carrier liquid detected with the aid of the sensor unit and/or of the additional sensor unit. In this case, it is particularly advantageous if the temperature is detected at the point at which the corresponding property information is also detected. Since the temperature generally has an influence on the property information (conductivity, density, etc.), the method may be carried out even more precisely by taking this factor into consideration when detecting or ascertaining the property information and/or the active agent concentration.

For detecting the property information with the aid of absorption, it is also possible, similar to the temperature, to also measure the pressure, so that for this purpose, the sensor unit may alternatively or additionally include a pressure sensor.

### BRIEF DESCRIPTION OF THE DRAWINGS

The present invention is explained by way of example in greater detail below with reference to the figures.

FIG. 1 schematically shows a representation of one exemplary embodiment of the spray device.

FIG. 2 schematically shows a representation of the control unit.

FIG. 3 shows a flow chart of a method for monitoring and/or controlling a deployment process.

### DETAILED DESCRIPTION OF EXAMPLE EMBODIMENTS

In the following description of preferred exemplary embodiments of the present invention, identical or similar reference numerals are used for elements which are represented in the various figures and act similarly, a repeated description of the elements being omitted.

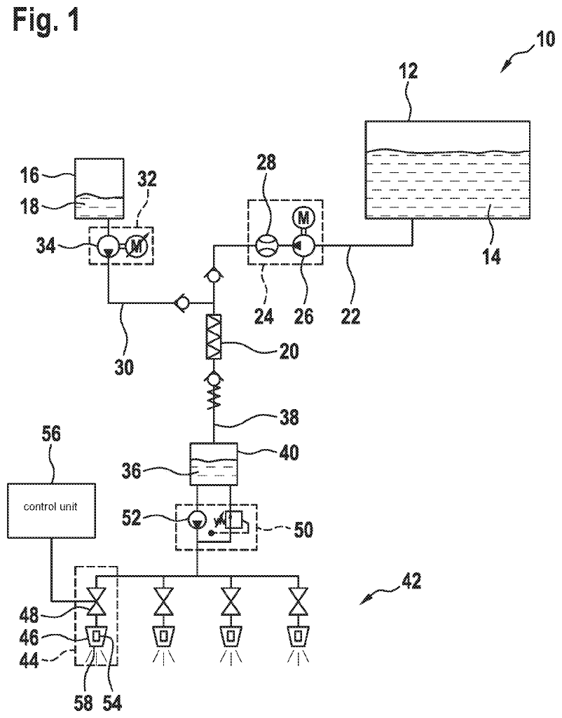

A schematic representation of an example spray device according to the present invention is depicted in FIG. 1, which is provided in its entirety with reference numeral 10.

Spray device 10 includes a liquid tank 12 including a liquid 14 and an active agent tank 16 including an active agent 18. Liquid 14 is a carrier liquid 14 or water 14.

Spray device 10 further includes a static mixing unit 20. Static mixing unit 20 is fluidically connected to liquid tank 12 via a liquid line 22. A liquid delivery unit 24 is situated in liquid line 22 in order to be able to feed or conduct liquid 22 to static mixing unit 20. Liquid delivery unit 24 in this case includes a delivery pump 26 and a volumetric flow meter 28. Similarly, static mixing unit 20 is further connected to active agent tank 16 via an active agent line 30. In turn, an active agent delivery unit 32 is situated in active agent line 30, in order to be able to feed or conduct active agent 18 to static mixing unit 20. Active agent delivery unit 32 in this case includes a metering pump 34. Accordingly, active agent 18 is intermixed with carrier liquid 14 with the aid of static mixing unit 20 to form a spray liquid 36.

In order to achieve a greater metering bandwidth with a higher metering accuracy, a spray liquid tank 40 is situated in a spray liquid line 38 downstream from static mixing unit 20. Spray liquid tank 40 in this case is designed as a buffer tank 40. Spray liquid tank 40 or buffer tank 40 is situated and designed in such a way that spray liquid 36 is filled from static mixing unit 20 into spray liquid tank 40, in order to then be conducted from spray liquid tank 40 to a nozzle system 42 including spray nozzle units 44. Each of spray nozzle units 44 includes a spray nozzle 46 for deploying spray liquid 36 and a valve 48 for controlling or regulating the deployed quantity of spray liquid.

To adjust the spray pressure at the spray nozzle units 44, spray device 10 further includes a spray liquid delivery unit 50, which is designed to feed spray liquid 36 from spray liquid tank 40 under pressure or under a defined pressure to nozzle system 42, or to spray nozzle units 44. Spray liquid delivery unit 50 in this case includes a constant pressure source including a pump 52.

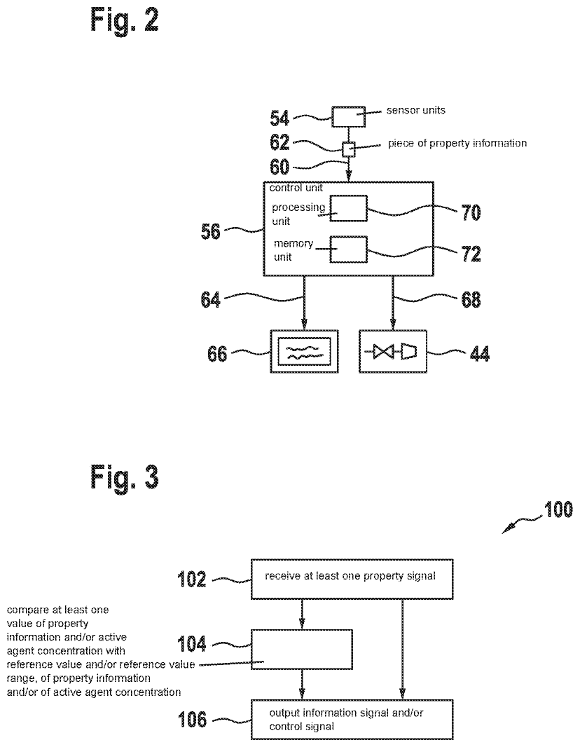

In order to then be able to monitor and or carry out in an optimized manner the deployment process of spray liquid 36 having a defined active agent concentration at spray nozzle units 44, spray device 10 further includes sensor units 54 at spray nozzles 46 of spray nozzle units 44 and a control unit 56 for controlling spray nozzle units 44. Sensor units 54 are each designed to detect—during the deployment process—a piece of property information of spray liquid 36 in a through-flow area 58 of spray nozzle units 44 or of spray nozzles 46 of spray nozzle units 44, an active agent concentration in spray liquid 36 being ascertainable using the property information. In FIG. 2, it is shown how the deployment process is monitored and controlled with the aid of control unit 56. The deployment process in this case is started manually.

As is shown in FIG. 2, control unit 56 is configured to receive a property signal 60 including a piece of property information 62 of spray liquid 36 detected with the aid of a sensor unit 54 of spray device 10 in corresponding through-flow area 58 of spray nozzle unit 44. Property information 62 in this case includes an electrical conductivity of spray liquid 36. Accordingly, sensor unit 54 includes a sensor for detecting the electrical conductivity and a sensor for detecting the temperature. Control unit 56 is also configured to output an information signal 64 to a display unit 66 and/or a control signal 68 to spray nozzle unit 44 as a function of property information 62 of spray liquid 36 and/or of an active agent concentration in spray liquid 36 ascertained using property information 62, in order to monitor and/or to control the deployment process. Control unit 56 in this case is configured to compare at least one value of property information 62 of spray liquid 54 with at least one predefinable reference value and/or one predefinable reference value range of property information 62 with the aid of a processing unit 70, in order as a function thereof to output information signal 64 to display unit 66 and/or control signal 68 to spray nozzle unit 44. Processing unit 70 is further designed to ascertain an active agent concentration in spray liquid 63 using property information 62. Control signal 68 is output, in particular, when property information 62 has reached the reference value and/or the reference value range. In this case, the control signal is designed to deactivate spray nozzle unit 44 in order to terminate the deployment process. Control unit 56 further includes a memory unit 72 for storing the pieces of property information 62, the ascertained values and the reference values.

FIG. 3 shows a flow chart of an example method 100 in accordance with the present invention for monitoring and/or controlling a deployment process of a spray liquid 36 having a defined active agent concentration at at least one spray nozzle unit 44 of a spray device 10 for deploying spray liquid 36, in particular, for agricultural purposes. Method 100 includes a step 102 of receiving at least one property signal 60 that includes a piece of property information 62 of spray liquid 36 detected with the aid of a sensor unit 54 of spray device 10 in a through-flow area 58 of the at least one spray nozzle unit 44, an active agent concentration in spray liquid 36 being ascertainable using property information 62. Finally, method 100 includes a step 106 of outputting an information signal 64 to a display unit 66 and/or a control signal 68 to spray nozzle unit 44 as a function of received property information 62 of spray liquid 36 and/or of an active agent concentration in spray liquid 36 ascertained using property information 62 in order to monitor and/or to control the deployment process Method 100 optionally also includes a step 104 of comparing at least one value of property information 62 and/or of the active agent concentration of spray liquid 36 with at least one predefinable reference value and/or one predefinable reference value range of property information 62 and/or of the active agent concentration, in order as a function thereof to output information signal 64 and/or control signal 68.

If an exemplary embodiment includes an “and/or” linkage between a first feature and a second feature, this is to be read in the sense that the exemplary embodiment according to one specific embodiment includes both the first feature and the second feature, and according to another specific embodiment, either only the first feature or only the second feature.

1-14. (canceled)

15. A method for monitoring and/or controlling a deployment process, of a spray liquid having a defined active agent concentration, at at least one spray nozzle unit of a spray device, for deploying the spray liquid for agricultural purposes, the method comprising the following steps:
receiving at least one property signal including a piece of property information of the spray liquid detected using a sensor unit of the spray device in a through-flow area of the at least one spray nozzle unit, an active agent concentration in the spray liquid being ascertainable using the property information; and
outputting, an information signal to a display unit and/or a control signal to the spray nozzle unit, as a function of the property information of the spray liquid and/or of an active agent concentration in the spray liquid ascertained using the property information, the information signal and/or the control signal being output to monitor and/or to control the deployment process.

16. The method as recited in claim 15, further comprising the following step:
receiving at least one additional property signal including a further piece of property information of the spray liquid ascertained using an additional sensor unit of the spray device in a through-flow area of an additional spray nozzle unit; and
outputting, as a function of the received additional property signal, the information signal to the display unit and/or the control signal to the additional spray nozzle unit.

17. The method as recited in claim 15, further comprising the following step:
comparing at least one value of the property information and/or of the active agent concentration of the spray liquid with at least one predefinable reference value and/or a predefinable reference value range, of the property information and/or of the active agent concentration, wherein the information signal and/or the control signal is output as a function of the comparison.

18. The method as recited in claim 17, wherein the value and/or the reference value and/or the reference value range, of the property information and/or of the active agent concentration, is ascertained using property information of a carrier liquid of the spray liquid detected using an additional sensor unit.

19. The method as recited in claim 18, wherein the value and/or the reference value and/or the reference value range, of the property information and/or of the active agent concentration, is ascertained using a temperature of the spray liquid and/or of the carrier liquid, detected using the sensor unit.

20. The method as recited in claim 17, wherein the information signal is output to the display unit and/or the control signal is output to the spray nozzle unit, when the value of the property information and/or of the active agent concentration in the spray liquid has reached the reference value and/or the reference value range and/or the reference value with a defined deviation, and/or the reference value range with a defined deviation.

21. The method as recited in claim 15, wherein the information signal is output at and/or after the termination of the deployment process and/or during the deployment process.

22. The method as recited in claim 15, wherein the information signal is output, and wherein the information signal includes a value of the property information and/or of the active agent concentration in the spray liquid, which is displayed on the display unit.

23. The method as recited in claim 15, wherein the control signal is output, and wherein the control signal is configured to close the spray nozzle unit to terminate the deployment process at the spray nozzle unit.

24. The method as recited in claim 15 wherein the detected piece of property information is selected one or more of the following: an electrical property, electrical conductivity, electrical permittivity, a visual property, an absorption property, an emission property, fluorescence, sound velocity.

25. A control unit for monitoring and/or controlling a deployment process, of a spray liquid having a defined active agent concentration, at at least one spray nozzle unit of a spray device, for deploying the spray liquid for agricultural purposes, the control unit configured to:
receive at least one property signal including a piece of property information of the spray liquid detected using a sensor unit of the spray device in a through-flow area of the at least one spray nozzle unit, an active agent concentration in the spray liquid being ascertainable using the property information; and
output, an information signal to a display unit and/or a control signal to the spray nozzle unit, as a function of the property information of the spray liquid and/or of an active agent concentration in the spray liquid ascertained using the property information, the information signal and/or the control signal being output to monitor and/or to control the deployment process.

26. A spray device for deploying a spray liquid for agricultural purposes, the spray liquid having a defined active agent concentration, the spray device comprising:
at least one spray nozzle unit;
sensor unit configured to detect a piece of property information of the spray liquid in a through-flow area of the at least one spray nozzle unit, an active agent concentration in the spray liquid being ascertainable using the property information; and
a control unit for monitoring and/or controlling the deployment of the liquid spray at the at least one spray nozzle unit, the control unit configured to:
receive, from the sensor unit, at least one property signal including the piece of property information of the spray liquid; and
output, an information signal to a display unit and/or a control signal to the spray nozzle unit, as a function of the property information of the spray liquid and/or of an active agent concentration in the spray liquid ascertained using the property information, the information signal and/or the control signal being output to monitor and/or to control the deployment process.

27. A non-transitory machine-readable memory medium on which is stored a computer program for monitoring and/or controlling a deployment process, of a spray liquid having a defined active agent concentration, at at least one spray nozzle unit of a spray device, for deploying the spray liquid for agricultural purposes, the computer program, when executed by a computer, causing the computer to perform the following steps:
receiving at least one property signal including a piece of property information of the spray liquid detected using a sensor unit of the spray device in a through-flow area of the at least one spray nozzle unit, an active agent concentration in the spray liquid being ascertainable using the property information; and
outputting, an information signal to a display unit and/or a control signal to the spray nozzle unit, as a function of the property information of the spray liquid and/or of an active agent concentration in the spray liquid ascertained using the property information, the information signal and/or the control signal being output to monitor and/or to control the deployment process.
